(19) United States
(12) Patent Application Publication
(10) Pub. No.: US 2008/0084856 A1
(43) Pub. Date: Apr. 10, 2008

(54) SYSTEM AND METHOD TO FACILITATE PATH SELECTION IN A MULTIHOP NETWORK

(75) Inventor: Shyamal Ramachandran, Heathrow, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Plantation, FL (US)

(21) Appl. No.: 11/539,474

(22) Filed: Oct. 6, 2006

(51) Int. Cl. H04B 7/216

(52) U.S. Cl. 370/342

(57) ABSTRACT

A multihop network includes at least one base station and a plurality of relay stations, Within each relay station, a method to facilitate path selection includes: maintaining a base station path metric from the relay station to the base station; maintaining a relay station link metric from the relay station to each of a plurality of other relay stations; comparing the current base station path metric and each of the other base station path metrics through the plurality of other relay stations; and selecting a path for routing messages from the relay station to the base station using the comparing step.

### FIELD OF THE INVENTION

The present invention relates generally to wireless communication systems and more particularly to the operation of a communication network utilizing relay stations.

### BACKGROUND

An infrastructure-based wireless network typically includes a communication network with fixed and wired gateways. Many infrastructure-based wireless networks employ a mobile unit or host which communicates with a fixed base station that is coupled to a wired network. The mobile unit can move geographically while it is communicating over a wireless link to the base station. When the mobile unit moves out of range of one base station, it may connect or “handover” to a new base station and starts communicating with the wired network through the new base station.

In comparison to infrastructure-based wireless networks, such as cellular networks or satellite networks, ad hoc networks are self-forming networks which can operate in the absence of any fixed infrastructure, and in some cases the ad hoc network is formed entirely of mobile nodes. An ad hoc network typically includes a number of geographically-distributed, potentially mobile units, sometimes referred to as “nodes,” which are wirelessly connected to each other by one or more links (e.g., radio frequency communication channels). The nodes can communicate with each other over a wireless media without the support of an infrastructure-based or wired network. Links or connections between these nodes can change dynamically in an arbitrary manner as existing nodes move within the ad hoc network, as new nodes join or enter the ad hoc network, or as existing nodes leave or exit the ad hoc network. Because the topology of an ad hoc network can change significantly techniques are needed which can allow the ad hoc network to dynamically adjust to these changes. Due to the lack of a central controller, many network-controlling functions can be distributed among the nodes such that the nodes can self-organize and reconfigure in response to topology changes.

One characteristic of the nodes is that each node can directly communicate over a short range with nodes which are a single “hop” away. Such nodes are sometimes referred to as “neighbor nodes.” When a node transmits packets to a destination node and the nodes are separated by more than one hop (e.g., the distance between two nodes exceeds the radio transmission range of the nodes, or a physical barrier is present between the nodes), the packets can be relayed via intermediate nodes (“multi-hopping”) until the packets reach the destination node. In such situations, each intermediate node routes the packets (e.g., data and control information) to the next node along the route, until the packets reach their final destination

IEEE 802.16 is a point-to-multipoint (PMP) system with one hop links between a base station (BS) and a subscriber station (SS). Such network topologies severely stress link budgets at the cell boundaries and often render the subscribers at the cell boundaries incapable of communicating using the higher-order modulations that their radios can support. Pockets of poor-coverage areas are created where high data-rate communication is impossible. This in turn brings down the overall system capacity. While such coverage voids can be avoided by deploying BSs tightly, this drastically increases both the capital expenditure (CAPEX) and operational expenditure (OPEX) for the network deployment. A cheaper solution is to deploy relay stations (RSs) (also known as relays or repeaters) in the areas with poor coverage and repeat transmissions so that subscribers in the cell boundary can connect using high data rate links.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an exemplary wireless communication network.

FIG. 1A illustrates an exemplary base station for use in the exemplary wireless communication network of FIG. 1 in accordance with some embodiments of the present invention.

FIG. 1B illustrates an exemplary relay station for use in the exemplary wireless communication network of FIG. 1 in accordance with some embodiments of the present invention.

FIG. 2 illustrates a network operating in accordance with some embodiments of the present invention.

FIG. 3 illustrates the network of FIG. 2 operating in accordance with some embodiments of the present invention.

FIG. 4 illustrates exemplary timelines of a method of allocation of network resources in accordance with some embodiments of the present invention.

FIG. 5 illustrates an exemplary association table stored in the base station of FIG. 1A in accordance with some embodiments of the present invention.

FIG. 6 illustrates exemplary timelines of an alternative method of allocation of network resources in accordance with some embodiments of the present invention.

FIG. 7 illustrates the network of FIG. 2 operating in accordance with some embodiments of the present invention.

FIG. 8 illustrates the network of FIG. 2 operating in accordance with some embodiments of the present invention.

FIG. 9 illustrates the network of FIG. 2 operating in accordance with some embodiments of the present invention.

FIG. 10 illustrates an exemplary neighbor table stored in the relay station of FIG. 1B in accordance with some embodiments of the present invention.

FIG. 11 illustrates a network in accordance with some embodiments of the present invention.

FIG. 12 is a flowchart illustrating an exemplary operation of the base station of FIG. 1A in accordance with some embodiments of the present invention.

FIG. 13 is a flowchart illustrating an exemplary operation of the relay station of 1B in accordance with some embodiments of the present invention.

FIG. 14 illustrates a message flow for the operation of the network of FIG. 11 in accordance with some embodiments of the present invention.

FIG. 15 illustrates the network of FIG. 11 operating in accordance with some embodiments of the present invention.

FIG. 16 illustrates an exemplary neighbor table stored in the relay station of FIG. 1B in accordance with some embodiments of the present invention.

FIG. 17 is a flowchart illustrating an exemplary operation of the relay station of 1B in accordance with some embodiments of the present invention.

FIG. 18 illustrates the network of FIG. 11 operating in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to facilitating path selection in a multihop network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of facilitating path selection in a multihop network described herein. The non-processor circuits may include, but are not limited to, a radio receiver, a radio transmitter, signal drivers, clock circuits, power source circuits, and user input devices. As such, these functions may be interpreted as steps of a method to facilitate path selection in a multihop network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

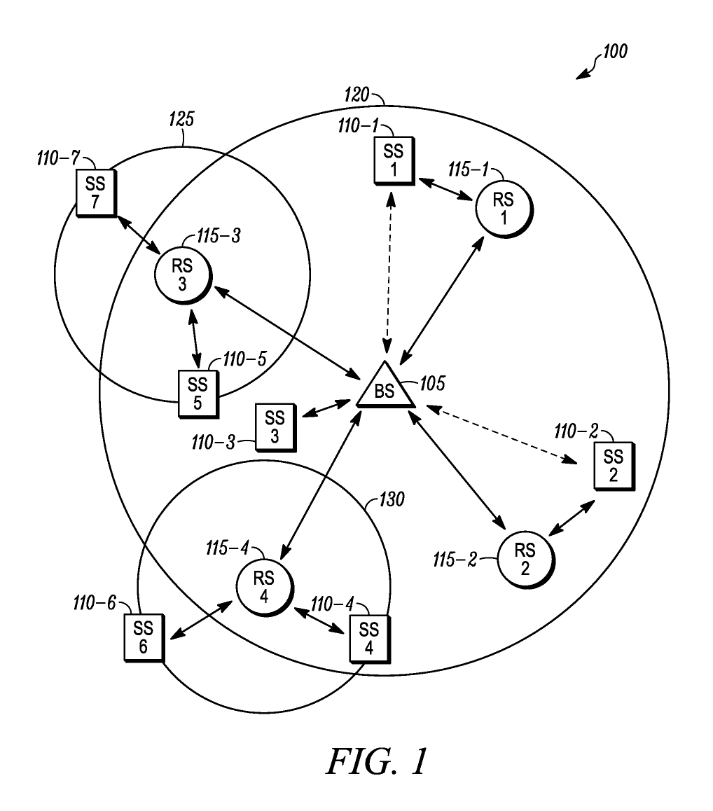

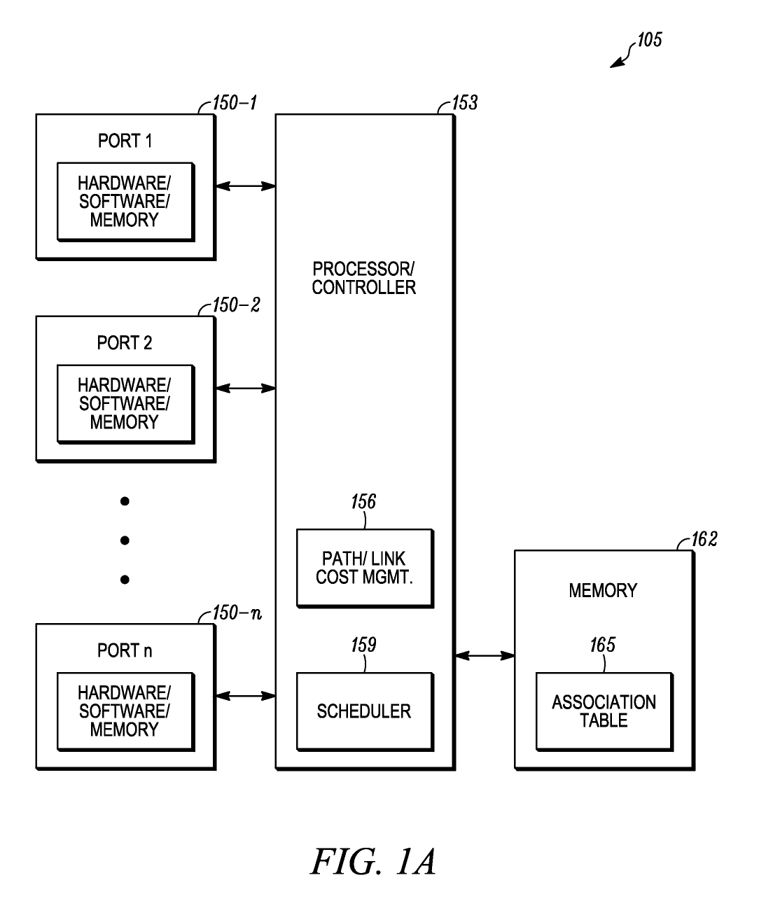

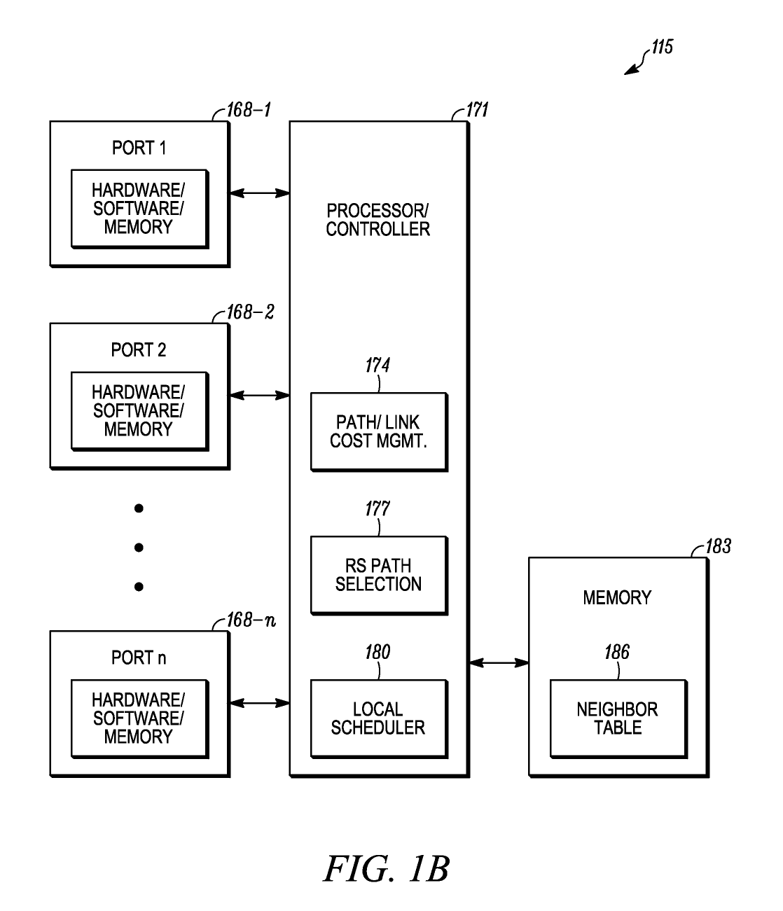

FIG. 1 illustrates an exemplary wireless communication network for use in the implementation of an embodiment of the present invention. FIG. 1 specifically illustrates an IEEE 802.16 network 100. As illustrated, the network 100 includes at least one base station 105 for communication with a plurality of subscriber stations 110-n. The exemplary network 100 further includes a plurality of relays 115-n (also known as relay stations or repeaters). The relays 115-n are deployed in the areas with poor coverage and repeat transmissions so that subscriber stations 110-n in a cell boundary can connect using high data rate links. In some cases relays 115-n may also serve subscriber stations 110-n that are out of the coverage range of the base station 105. In some networks, the relays 115-n are simpler versions of the base station 105, in that they do not manage connections, but only assist in relaying data. Alternatively, the relays 115-n can be at least as complex as the base station 105.

FIG. 1A illustrates an exemplary base station 105 in accordance with some embodiments of the present invention. As illustrated, the base station 105 comprises a plurality of ports 150-n, a controller 153, and a memory 162.

Each port 150-n provides an endpoint or “channel” for network communications by the base station 105. Each port 150-n may be designated for use as, for example, an IEEE 802.16 port or a backhaul port or an alternate backhaul port. For example, the base station 105 can communicate with one or more relay stations and/or one or more subscriber stations within an 802.16 network using an IEEE 802.16 port. An IEEE 802.16 port, for example, can be used to transmit and receive both data and management information.

A backhaul port similarly can provide an endpoint or channel for backhaul communications by the base station 105. For example, the base station 105 can communicate with one or more other base stations using the backhaul, which can be wired or wireless, via the backhaul port.

Each of the ports 150-n are coupled to the controller 153 for operation of the base station 105. Each of the ports employs conventional demodulation and modulation techniques for receiving and transmitting communication signals respectively, such as packetized signals, to and from the base station 105 under the control of the controller 153. The packetized data signals can include, for example, voice, data or multimedia information, and packetized control signals, including node update information.

The controller 153 includes a path/link cost management block 156 and a scheduler block 159, each which will be described in detail herein. It will be appreciated by those of ordinary skill in the art that the path/link cost management block 156 and the scheduler block 159 and the parameters utilized therein can be hard coded or programmed into the base station 105 during manufacturing, can be programmed over-the-air upon customer subscription, or can be a downloadable application. It will be appreciated that other programming methods can be utilized for programming the path/link cost management block 156 and the scheduler block 159 into the base station 105. It will be further appreciated by one of ordinary skill in the art that path/link cost management block 156 and the scheduler block 159 can be hardware circuitry within the base station. In accordance with the present invention, the path/link cost management block 156 and the scheduler block 159 can be contained within the controller 153 as illustrated, or alternatively can be an individual block operatively coupled to the controller 153 (not shown).

To perform the necessary functions of the base station 105, the controller 153 is coupled to the memory 162, which preferably includes a random access memory (RAM), a read-only memory (ROM), an electrically erasable programmable read-only memory (EEPROM), and flash memory. The memory 162 includes storage locations for the storage of an association table 165.

It will be appreciated by those of ordinary skill in the art that the memory 162 can be integrated within the base station 105, or alternatively, can be at least partially contained within an external memory such as a memory storage device. The memory storage device, for example, can be a subscriber identification module (SIM) card.

FIG. 1B illustrates an exemplary relay station 115 in accordance with some embodiments of the present invention. As illustrated, the relay station 115 comprises a plurality of ports 168-n. Each port 150-n may be designated for use as, for example, an IEEE 802.16 port or a backhaul port or an alternate backhaul port. For example, the plurality of ports 168-n can include an IEEE 802.16 port, which is used to communicate with one or more base stations, one or more relay stations and/or one or more subscriber stations. The relay station 115 further comprises a controller 171 and a memory 183.

An IEEE 802.16 port, for example, provides an endpoint or “channel” for 802.16 network communications by the relay station 115. For example, the relay station 115 can communicate with one or more base stations and/or one or more relay stations and/or one or more subscriber stations within an 802.16 network using the IEEE 802.16 port. An IEEE 802.16 port, for example, can be used to transmit and receive both data and management information.

Each of the ports 168-n are coupled to the controller 171 for operation of the relay station 115. Each of the ports employs conventional demodulation and modulation techniques for receiving and transmitting communication signals respectively, such as packetized signals, to and from the relay station 115 under the control of the controller 171. The packetized data signals can include, for example, voice, data or multimedia information, and packetized control signals, including node update information.

In accordance with the present invention, the controller 171 includes a path/link cost management block 174, a relay station path selection block 177, and a local scheduler 180. It will be appreciated by those of ordinary skill in the art that the path/link cost management block 174, the relay station path selection block 177, and the local scheduler 180 and the parameters utilized therein can be hard coded or programmed into the relay station 115 during manufacturing, can be programmed over-the-air upon customer subscription, or can be a downloadable application. It will be appreciated that other programming methods can be utilized for programming the path/link cost management block 174, the relay station path selection block 177, and the local scheduler 180 into the relay station 400. It will be further appreciated by one of ordinary skill in the art that the alternate backhaul detection mechanism can be hardware circuitry within the relay station 115. In accordance with the present invention, the path/link cost management block 174, the relay station path selection block 177, and the local scheduler 180 can be contained within the controller 171 as illustrated, or alternatively can be individual blocks operatively coupled to the controller 171 (not shown). The operation of each of these blocks will be described herein.

To perform the necessary functions of the relay station 115, the controller 171, and/or the path/link cost management block 174, the relay station path selection block 177, and the local scheduler 180 are each coupled to the memory 183, which preferably includes a random access memory (RAM), a read-only memory (ROM), an electrically erasable programmable read-only memory (EEPROM), and flash memory. The memory 183 includes storage locations for the storage of a neighbor table 186.

It will be appreciated by those of ordinary skill in the art that the memory 183 can be integrated within the relay station 115, or alternatively, can be at least partially contained within an external memory such as a memory storage device. The memory storage device, for example, can be a subscriber identification module (SIM) card. A SIM card is an electronic device typically including a microprocessor unit and a memory suitable for encapsulating within a small flexible plastic card. The SIM card additionally includes some form of interface for communicating with the relay station 115.

In typical systems such as the network 100, IEEE 802.16 base stations (BSs) do not forward traffic to other base stations on the IEEE 802.16 air interface. Further, IEEE 802.16 Relays (RSs) can forward traffic to base stations, relay stations, or subscriber stations (SSs). As previously mentioned, the relay stations are themselves managed/controlled by at least one of the base stations. Further relay stations can be fixed, nomadic or mobile.

As illustrated in FIG. 1, the relay stations 115-n of the network 100 can provide communication coverage outside the base station coverage area 120. For example, a relay station 3 115-3 provides a coverage area 125 and a relay station 4 115-4 provides a coverage area 130 which include communication coverage outside of a coverage area 120 of the base station 105. Thus communication by relay station 3 115-3 can include communication for subscriber station 7 110-7; and communication by relay station 4 115-4 can include communication for subscriber station 6 110-6, which otherwise would not be possible directly to the base station 105. Since subscriber station 6 110-6 and subscriber station 7 110-7 cannot be controlled by the base station 105 directly, they are entirely controlled by the relay stations 115-4 and 115-3 respectively, or by the base station 105 through the relay stations 115-4 and 115-3 respectively.

In summary, the relay stations (RS) introduced in an IEEE 802.16 system, can provide coverage and capacity gains by extending the base station's (BS) range and permitting subscriber stations (SS) to multihop to the BS. The method described herein allows a relay station to proactively range with one or more other relay stations, and maintain path metrics to reach the base station through these relay stations, so that it may route packets towards the base station through another relay station instead of directly accessing the base station.

Forming a Two Hop Path

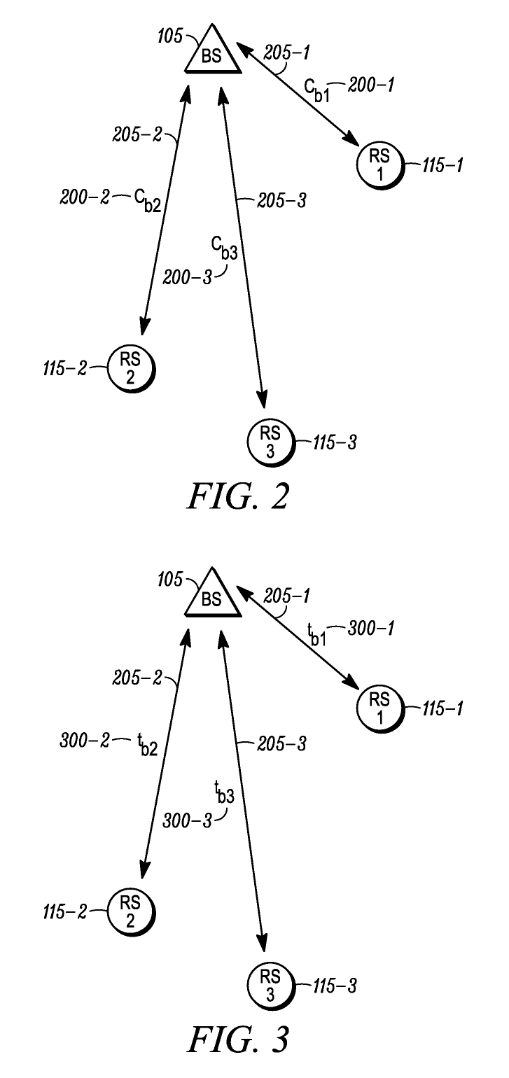

FIG. 2 illustrates a portion of the network 100 of FIG. 1. Specifically, FIG. 2 illustrates the base station 105 and three relay stations (relay station 1 115-1, relay station 2 115-2, and relay station 3 115-3). As will be appreciated by those of ordinary skill in the art, a base station in an IEEE 802.16 network transmits “metrics” on the downlink, which might be used by the relay stations when choosing between multiple base stations to associate with during network entry. These “metrics” are generally numeric representations of the cost of accessing the base station. In a network such as illustrated in FIG. 2, the base station 105 can include an optional information element (IE), a downlink MAP message (DL-MAP) extended IE, in its DL-MAP message with the metric. This metric value may depend on the cost of the backhaul at the base station 105. It will be appreciated by those of ordinary skill in the art that other mechanisms can alternatively be used by a base station to communicate metrics within a network. This is the initial metric that the base station announces and the relay stations 115-1, 115-2, and 115-3 use this value to associate with the base station. Generally, the relay stations 115-1, 115-2, and 115-3 use the initial metric announced by the base stations to select one base station 105 to associate with from the several base station options that are available.

Relay stations 115-1, 115-2, and 115-3 calculate their own metric by determining the cost to reach the base station 105 in which they are associated. This metric may depend on the physical layer (PHY) signal quality between the base station 105 and the specific relay station. The metric, for example, may depend on other parameters such as the load on the relay station, the size of the relay station's internal queues and the busyness of the neighborhood.

FIG. 2 illustrates the costs associated with the links connecting each of the relay stations with the base station. For example, as illustrated, a first cost C_{b1} 200-1 is associated with a first link 205-1 between the relay station 1 115-1 and the base station 105. A second cost C_{b2} 200-2 is associated with a second line 205-2 between the relay station 2 115-2 and the base station 105. A third cost C_{b3} 200-3 is associated with a third link 200-3 between the relay station 3 115-3 and the base station 105. Once a relay station attempting network entry has selected a base station, to reach the base station, unicast message exchange between them can be used to continuously update hop-by-hop metrics.

Relay stations themselves, after associating with a base station, announce the metric to reach the base station through themselves to other nodes in the network. This announced metric information is used by other relay stations further down stream from the base station.

Once a tree network is formed rooted at the base station 105, communications towards the base station 105 (uplink) are offset in time by the appropriate timing advance required in order to be received correctly at the base station 105. This timing offset is determined using a ranging procedure. The ranging procedure for example can be as specified in the IEEE 802.16 standard, or any equivalent ranging procedure. For example, the relay station 1 115-1 uses a ranging procedure to determine the propagation delay between itself and the base station 105.

FIG. 3 illustrates exemplary propagation delays within the network of FIG. 2. The propagation delay t_{b1} 300-1 is used by relay station 1 115-1 to offset its transmissions in time such that the propagation delay is compensated when its transmissions are received at the base station 105. Similarly, the relay station 2 115-2 uses a ranging procedure to determine the propagation delay between itself and the base station 105. This propagation delay t_{b2} 300-2 is used by relay station 2 115-2 to offset its transmissions in time such that the propagation delay is compensated when its transmissions are received at the base station 105. Similarly, the relay station 3 115-3 uses a ranging procedure to determine the propagation delay between itself and the base station 105. This propagation delay t_{b3} 300-3 is used by relay station 3 115-3 to offset its transmissions in time such that the propagation delay is compensated when its transmissions are received at the base station 105.

If a relay station that is already in the network wants to change its next hop towards its associated base station, it must learn the timing advance to reach this new next hop device. In the example shown in FIGS. 2 and 3, if relay station 3 115-3 wants to reach the base station 105 through either relay station 1 115-1 or relay station 2 115-2, it needs to know the timing advance required to transmit to those nodes. Relay station 3 115-3 should also learn which node is better suited (from an end-to-end cost perspective) as the next hop towards the base station 105.

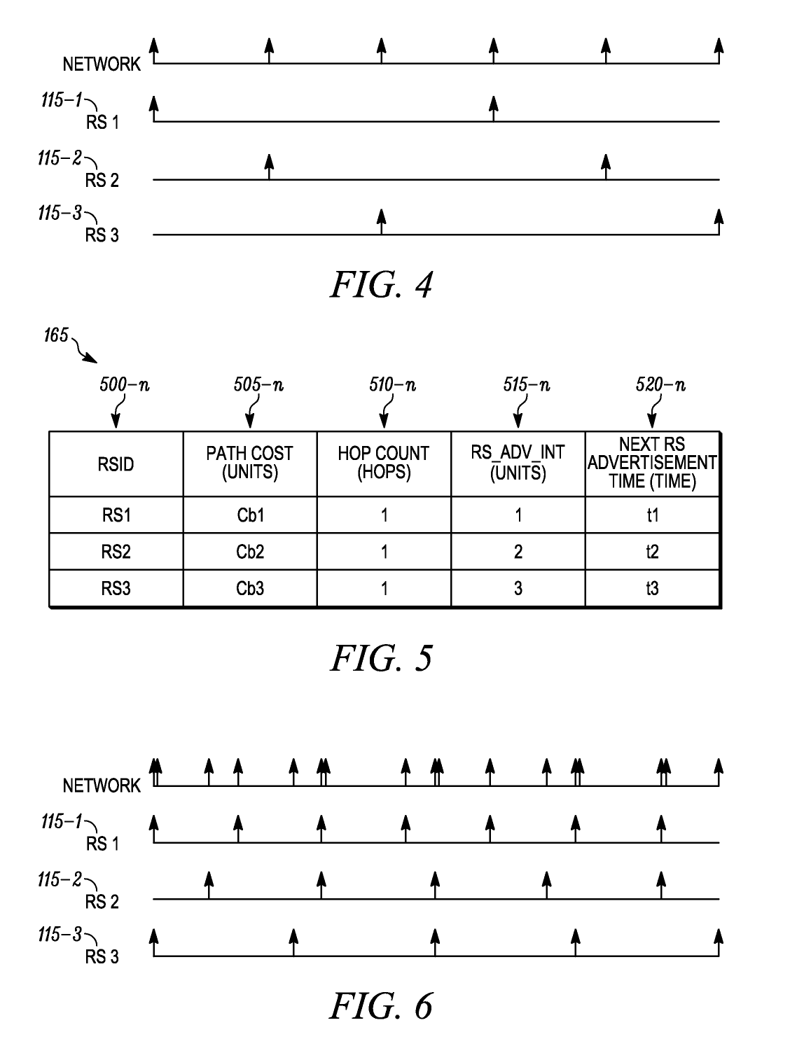

The base station 105 maintains a configurable parameter, relay station advertisement interval (RS_ADV_INT). Every RS_ADV_INT time interval, the base station 105 allocates an uplink transmission opportunity called relay station Advertisement Opportunity, to one of the relay stations for the purpose of “relay station advertisement”. For instance the base station 105 may give relay station 1 115-1 a relay station Advertisement Opportunity, and after a RS_ADV_INT give relay station 2 115-2 a similar opportunity. The base station 105 may then give relay station 3 115-3 a similar opportunity RS_ADV_INT after relay station 2's 115-2 opportunity. This method of allocation is shown in FIG. 4, where RS1 115-1, RS2 115-2 and RS3 115-3 have the same RS_ADV_INT period. The “Network” timeline shows the overall outcome of the allocations for all three relay stations.

Alternatively, the base station 105 may maintain a separate RS_ADV_INT parameter for each relay station. This value may be stored in an Association Table 165 such as illustrated in FIG. 5. The association table 165 includes, for example, an entry for each relay station 115-n in the network which the base station 105 is communicating with. Each entry for each relay station 115-n can include, for example, a RSID 500-n a path cost 505-n, a RS_ADV_INT 515-n, and a next RS advertisement time 520-n. For example, the value of the RS_ADV_INT 515-1 for RS1 115-1 may be RS_ADV_INT_RS1. The base station may then give RS1 115-1 a RS Advertisement Opportunity every RS_ADV_INT_RS1 time 515-1.

As illustrated in FIG. 5, the value of the RS_ADV_INT 515-n that the base station 105 maintains for each relay station 115-n may be different. The base station 105 may assign a RS_ADV_INT value based on the needs of the relay station 115-n. For example, if the base station 105 learns of the capability of a relay station to be mobile, the base station may assign that relay station a smaller RS_ADV_INT 515-n, so that that mobile relay station gets more frequent RS Advertisement Opportunities.

This method of allocation is shown in FIG. 6, where RS1 115-1 has the smallest RS_ADV_INT period value, RS2 115-2 has an RS_ADV_INT period larger than RS1 115-1 and RS3 115-3 has an RS_ADV_INT period larger than RS2 115-2. The “Network” timeline shows the overall outcome of the allocations for all three relay stations.

In any case, the base station takes turns with making RS Advertisement Opportunity allocation for each of the relay stations it controls. The base station makes a declaration of this allocation in the uplink MAP message (UL-MAP). Along with the declaration of the allocation in the UL-MAP, the base station also includes one or more of the following additional information:
1. An RS identifier (RSID) for identification of the relay station that this opportunity is meant for (for example: the RSID can be the relay station's MAC address).
2. A pseudorandom sequence identifier (PSID) that the relay station will transmit in the given opportunity.
3. A Total Timing Offset field which is the timing offset between the base station clock and the local clock (which is the timing offset of the local device). This field carries the value zero when the base station transmits the RS Advertisement Opportunity.
4. A cost field including the metric or cost of reaching the base station from the RS that is meant to use this opportunity.

It will be appreciated by those of ordinary skill in the art that a transmission opportunity will carry the start time of the allocation and the duration per the base station's local clock.

This message can be conveyed in the UL-MAP by using the UL_Extended_IE or by means of a separate message or information element carrying the same information.

The object of this message is to inform all relay stations, including the relay station for which the RS Advertisement Opportunity is meant, of the opportunity and the additional details listed above. The UL-MAP message is used as the exemplary embodiment in the rest of this invention. In this manner, this uplink transmission opportunity is now known to all the relay stations including the relay station that this opportunity is meant for.

It will be appreciated by those of ordinary skill in the art that the pseudorandom sequence chosen can be any sequence from a family of sequences agreed upon beforehand. For example, the pseudorandom sequence can be a preamble sequence used by the relay station. The present invention informs other relay stations of the sequence the advertising relay station will transmit and when it will transmit.

Assume that in the example shown in FIGS. 2 and 3, the base station 105 makes an RS Advertisement Opportunity announcement for RS1 115-1. It would include in the advertisement information such as (RS1, PS1, 0, C_{b1}), implying that this is an allocation for RS1 115-1, the pseudo-random sequence that RS1 115-1 will transmit is PS1, the Total Timing Offset from the base station's clock is zero (since this is an advertisement transmission from the BS itself) and the Cost of reaching the base station 105 from RS1 115-1 is C_{b1} 200-1.

RS1 115-1 upon receiving this allocation in the UL_MAP, will prepare to transmit the code PS1 at max power level (or another standard power level agreed upon by all nodes a priori) such that it ignores the timing advance, t_{b1} 300-1, that it maintains with the base station 105. In other words, RS1 115-1 will prepare to transmit PS1 as if it were co-located with the base station 105.

All other relay stations, namely RS2 115-2 and RS3 115-3, will prepare to receive PS1 at the time specified in the allocation, such that they are co-located with the base station 105. RS2 115-2 and RS3 115-3 can do this by ignoring their own timing offsets t_{b2} 300-2 and t_{b3} 300-3. RS2 115-2 and RS3 115-3 also note in their “neighbor table”, an entry for RS1 115-1, containing the RSID (RS1 in this example) and the cost that RS1 115-1 incurs in reaching the base station 105 (C_{b1} 200-1 in this example).

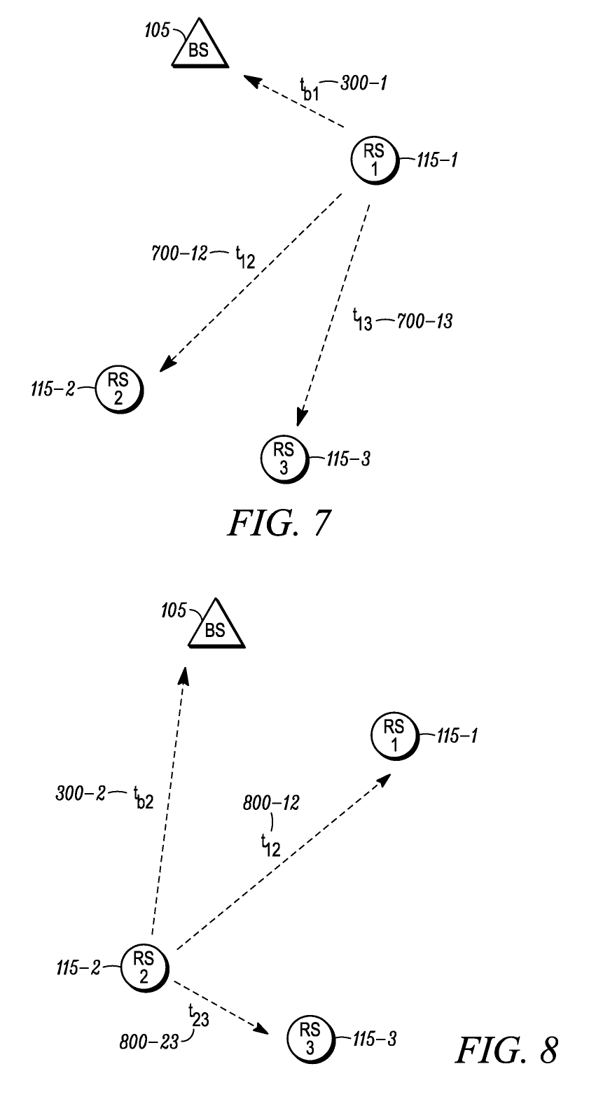

When RS1 115-1 transmits PS1, RS2 115-2 and RS3 115-3 receive PS1 and are able to determine an estimate on the signal-to-interference-and-noise ratio (SINR) and the timing offset between them. As shown in FIG. 7, RS2 115-2 learns that its timing offset to RS1 115-1 is t₁₂ 700-12, and RS3 115-3 learns that its timing offset to RS1 115-1 is t₁₃ 700-13. Both RS2 115-2 and RS3 115-3 include this timing offset and SINR information in their neighbor table entry for RS1 15-1. RS2 115-2 and RS3 115-3 also compute the cost of their reaching RS1 115-1 based on the SINR and store that information in their respective neighbor tables as well. RS2 115-2 and RS3 115-3 may combine this cost of reaching RS1 115-1 with the cost of reaching the base station 105 from RS1 115-1 received from the base station's announcement, and derive the total cost of reaching the base station 105 through RS1 115-1. This information may also be stored in their respective neighbor tables.

In the same manner, when the base station 105 allocates an RS Advertisement Opportunity for RS2 115-2, RS2 115-2 transmits the recommended PS code; and RS1 115-1 and RS3 115-3 are able to determine their timing advance to RS2 115-2 and also measure the SINR. This is shown in FIG. 8 where the timing offset from RS1 115-1 to RS2 115-2 is t₁₂ 800-12 and the timing offset between RS3 115-3 and RS2 115-2 is t₂₃ 800-23. RS1 115-1 and RS3 115-3 derive the total cost of reaching the base station 105 through RS2 115-2. This process of RS Advertisement is repeated every time an allocation is made, in order to improve the confidence in the measurements.

In this manner each relay station can learn of the timing advance required to switch to another relay station as the next hop. Each relay station is also in a position to determine from its own SINR measurement and from the base station's metric advertisement in the RS Advertisement Opportunity the aggregate path metric between itself and the base station through another relay station. Therefore, each relay station is in a position to select the best “next hop relay station” to reach the base station.

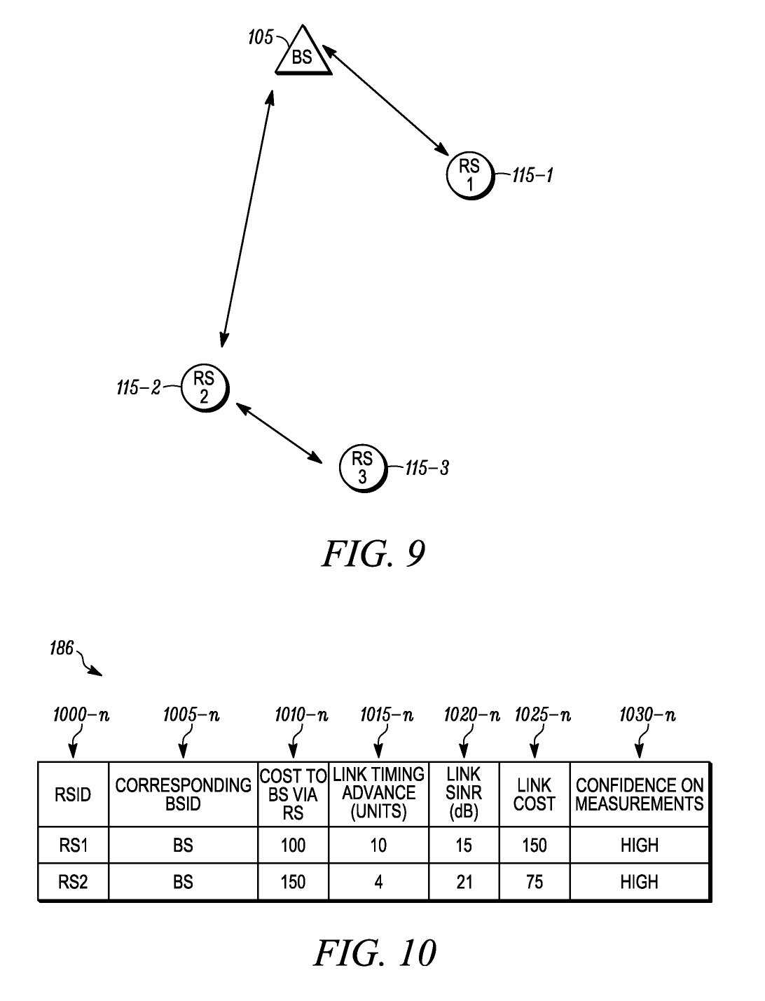

In this example network, RS3 115-3 might select RS2 115-2 to reach the BS 105, as shown in FIG. 9 using information stored in RS3's neighbor table. An exemplary neighbor table 186 at RS3 115-3 is illustrated in FIG. 10. The neighbor table 186, for example and as illustrated, includes an entry for each neighbor relay station for which the relay station 115-3 communicates. The entry for each relay station 115-n, for example, includes an RSID 1000-n, a corresponding BSID 1005-n, a cost to the base station via the relay station 1010-n, a link timing advance 1015-n, a link SINR 1020-n, a link cost 1025-n, and a confidence on measurements 1030-n. The total path metric from RS3 115-3 to the base station 105 via each relay station 115-n is then calculated as the cost to the base station via the relay station 1010-n plus the link cost 1025-n. For the example of FIG. 10, the total path metric from RS3 115-3 to the BS 105 through RS1 115-1 is 250 (100+150) and through RS2 115-2 is 225 (150+75).

Each relay station also informs the base station of its updated path metric to the base station periodically. Informing the base station can typically be accomplished over the existing path using a method such as an explicit message from the relay station to the base station across multiple hops, a symmetric measurement technique through periodic transmissions along the multihop path, and/or a unicast route request (RREQ)/route reply (RREP) session over the multihop path, or an equivalent.

Forming a Multihop Path

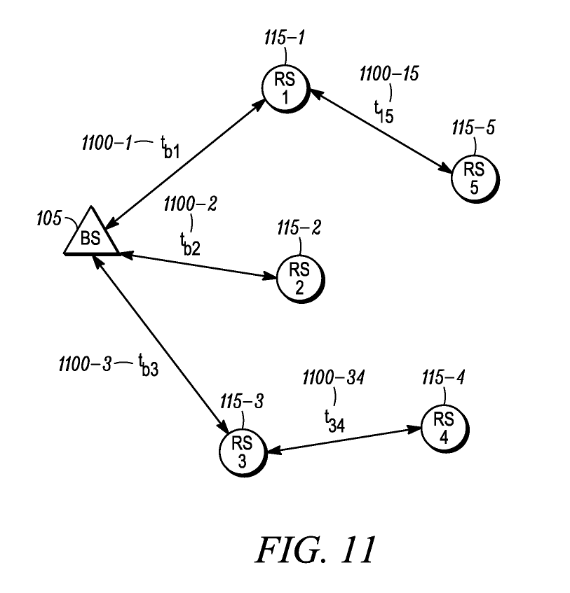

FIG. 11 illustrates a network comprising a base station 105 and relay stations 1 through 5 (115-1, 115-2, 115-3, 115-4, and 115-5). The timing advances directly to the base station 1100-n or between adjacent nodes 1100-nm are also shown in FIG. 11.

The base station 105 is aware of the cost incurred by each of the relay stations 115-n in reaching the base station 105 using the current paths (because the relay stations 115-n inform the base station 105 of this value periodically).

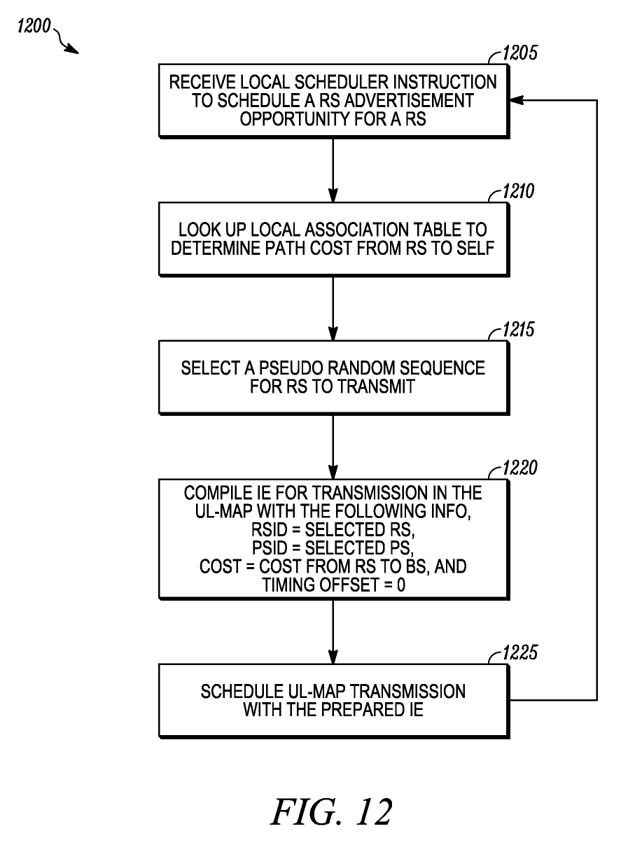

A method of operation 1200 carried out at the base station 105 of FIG. 11 is shown in FIG. 12. As illustrated, the operation begins with Step 1205, in which the base station 105 receives a local scheduler instruction to schedule a relay station advertisement opportunity for relay station 4. The base station 105, next, in Step 1210, uses its local association table to determine the path cost from RS4 115-4 to itself. Next, in Step 1215, the base station 105 selects a pseudo random sequence for RS4 115-4 to transmit. Next, in Step 1220, the base station 105 compiles the UL-MAP IE or any other message making the allocation including the following information.
1. RS4—the RSID to identify the RS for whom the allocation is being made.
2. PS2—the ID of the PS code that RS4 should transmit.
3. Zero “0”—for the timing offset between the BS clock and the local clock (since this is the BS itself).
4. C4—Assume (C4=C₃₄+C_{b3}) is the cost of reaching the BS through RS4. Here C_{b3} is the cost of reaching the BS from RS3 and C₃₄ is the cost over the link between RS3 and RS4.

It will be appreciated by those of ordinary skill in the art that a transmission opportunity will always carry the start time of the allocation and the duration per the base station's local clock. Lastly, in Step 1225, the base station 105 schedules the UL-MAP transmission with the prepared IE.

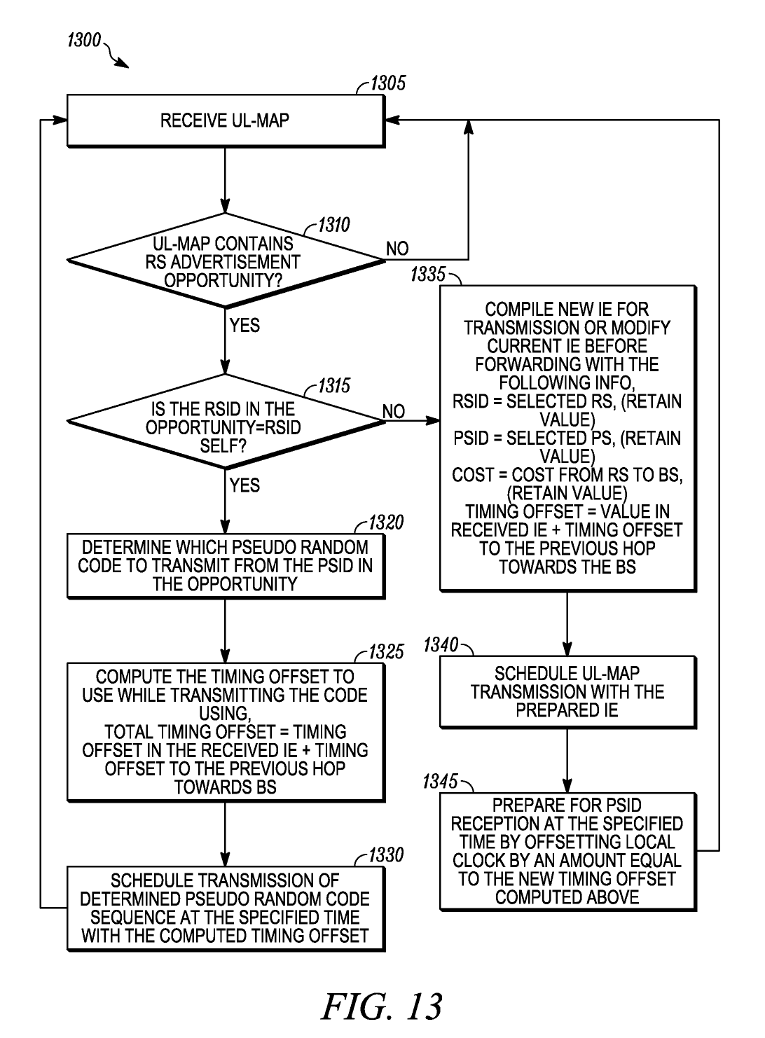

The process 1300 of handling RS Advertisement Opportunity allocation messages at a relay station is shown in FIG. 13. As illustrated in FIG. 13, the process 1300 begins in Step 1305 with the relay station receiving a UL-MAP. Next, in Step 1310, the relay station determines whether the received UL-MAP contains an RS Advertisement Opportunity. When the received UL-MAP does not contain an RS Advertisement Opportunity, the process cycles back to Step 1305 for receiving another UL-MAP. When the received UL-MAP contains an RS Advertisement Opportunity, the operation continues to Step 1315 in which the relay station determines whether the RSID in the RS Advertisement Opportunity is the relay station's RSID.

When the RSID in the RS Advertisement Opportunity is the relay station's RSID, the operation continues to Step 1320 in which the relay station determines which pseudo random code to transmit from the PSID of the received RS Advertisement Opportunity. Next, in Step 1325, the relay station computes the timing offset to use while transmitting the code using a total timing offset equal to the timing offset in the received IE plus the timing offset to the previous hop towards the base station. Next, in Step 1310, the relay station schedules transmission of the determined pseudo random code sequence at the specified time with the computed timing offset. The operation then cycles back to Step 1305 for receiving another UL-MAP.

When, in Step 1315, the RSID in the RS Advertisement Opportunity is not the relay station's RSID, the operation continues to Step 1335 in which the relay station compiles a new IE for transmission or modifies a current IE before forwarding with the following information:
1. RSID=the RS selected by the BS (retain value)
2. PSID=the PS selected by the BS (retain value)
3. Cost=the cost from the selected RS to the base station (retain value)
4. Total timing offset=value in the received IE+the timing offset to the previous hop towards the base station (update value)

Next, in Step 1340, the relay station schedules the UL-MAP transmission with the prepared IE. Next, in Step 1345, the relay station prepares for PSID reception at the specified time by offsetting the local clock by an amount equal to the new timing offset computed in Step 1335. The operation then cycles back to Step 1305 and the relay station awaits receipt of another UL-MAP.

Referring back to the network illustrated in FIG. 11, RS1 115-1, RS2 115-2 and RS3 115-3 transmit (or retransmit the base station's version with modifications) their own version of the transmission opportunity in their own UL-MAP messages. They repeat the RSID, PSID and cost as is. However each relay station, before transmitting its own UL-MAP comprising an RS Advertisement Opportunity allocation will increment the Total Timing Offset value that was present originally in the message with the timing offset that it maintains to the upstream node. This upstream node may be another relay station 115-n or the base station 105 itself. Specifically, when RS1 115-1 transmits the RS Advertisement Opportunity allocation it transmits the timing offset value of (t_{b1}+0=t_{b1}). RS2 115-2 and RS3 115-3 transmit (t_{b2}+0=t_{b2}) and (t_{b3}+0=t_{b3}) respectively.

In some embodiments of the present invention, a relay station can choose not to forward the RS Advertisement Opportunity if it knows that there are no other relay stations downstream from it.

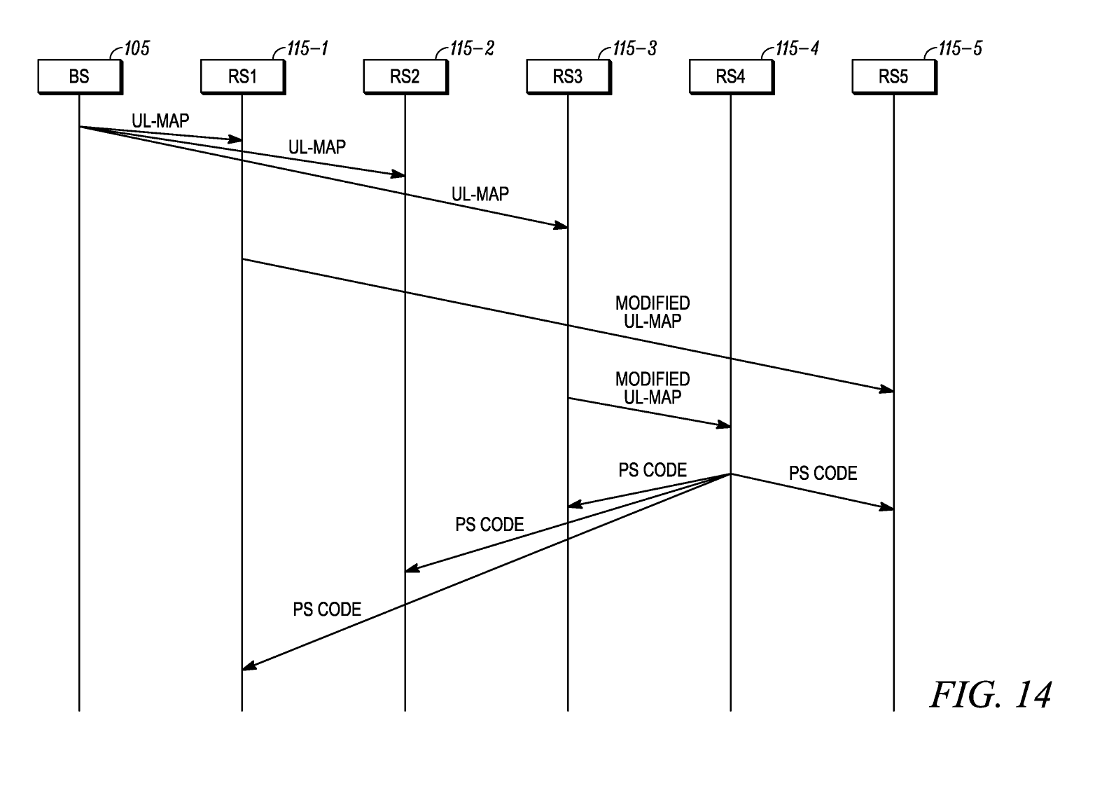

FIG. 14 illustrates a message flow in the network of FIG. 11 in order to facilitate a RS Advertisement from RS4 115-4. As illustrated in FIG. 14, RS5 115-5 and RS4 115-4 receive the allocations from RS1 115-1 and RS3 115-3 respectively, since they are associated with them (and are synchronized to their downlink frame structure).

RS5 115-5 transmits its own (or retransmits modified) UL-MAP (not shown in FIG. 14) with the RS Advertisement Opportunity, but updates the Total Timing Offset value by incrementing it by its own offset to RS1 115-1. Therefore RS5 115-5 transmits a new value (t₁₅+t_{b1}+0). This transmission is for any downstream relay stations, if present.

RS4 115-4 learns that this allocation is meant for itself, from the RSID. It prepares to transmit code PS2 ignoring the sum of its own timing advance to RS3 115-3 and the timing offset included in the allocation by RS3 115-3. Note that the sum total of these two numbers brings RS4 115-4 to the same reference clock as the base station 105. In other words RS4 115-4 prepares to transmit PS2 at the allocated time as if it were co-located with the base station 105.

RS5 115-5 expects to receive PS2 from RS4 115-4 at a time ahead of its clock by an amount equal to the sum of its own timing offset to the previous hop (RS1 115-1) and the timing offset value carried in the allocation itself (as set by RS1 115-1).

RS2 115-2 expects to receive PS2 from RS4 115-4 at a time ahead of its clock by an amount equal to the sum of its own timing offset to the previous hop (BS 105) and the timing offset value carried in the allocation itself (in this case the value is “0” since the previous hop is the BS 105 itself). Similarly, RS3 115-3 and RS1 115-1 also know when to expect the transmission of PS2 from RS4 115-4.

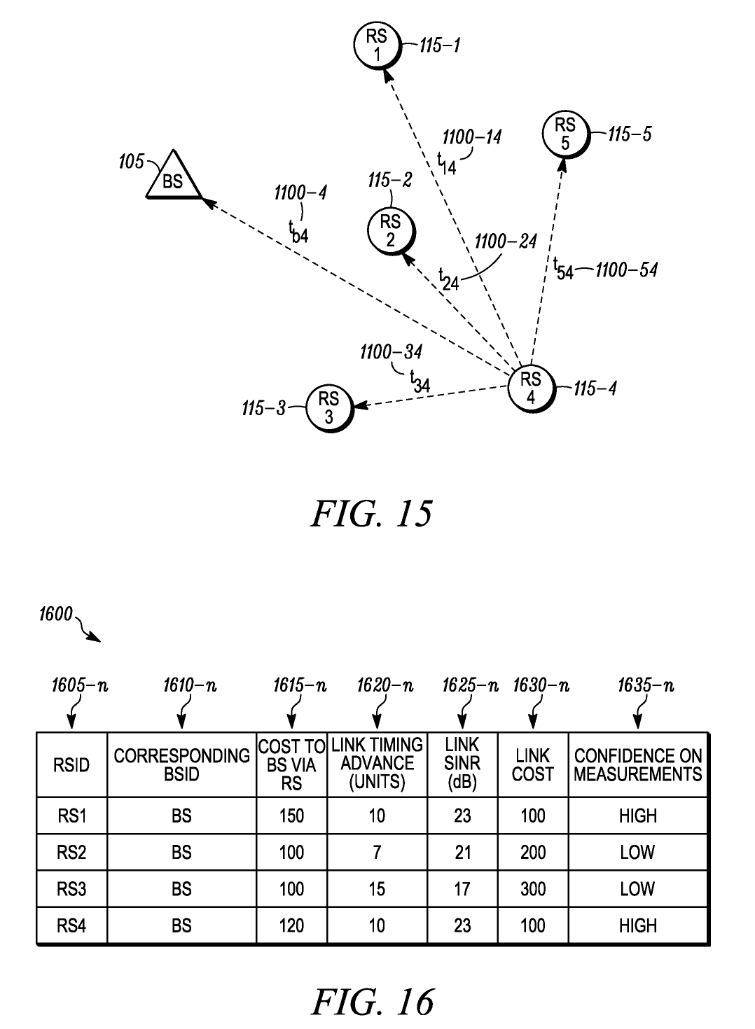

As shown in FIG. 15, all relay stations 115-n receive a PS2 transmitted by RS4 115-4 and make timing advance measurements and SINR measurements. These values are tabulated in the neighbor table as explained in the previous example. An exemplary neighbor table 1600 at RS5 115-5 is shown in FIG. 16. As illustrated in FIG. 16, the neighbor table 1600 includes an entry for each relay station 115-n in which the relay station RS5 115-5 communicates. Each entry includes an RSID 1605-n, a corresponding BSID 1610-n, a cost to the base station via the relay station 1615-n, a link timing advance 1620-n, a link cost 1630-n, and a confidence on measurements 1635-n.

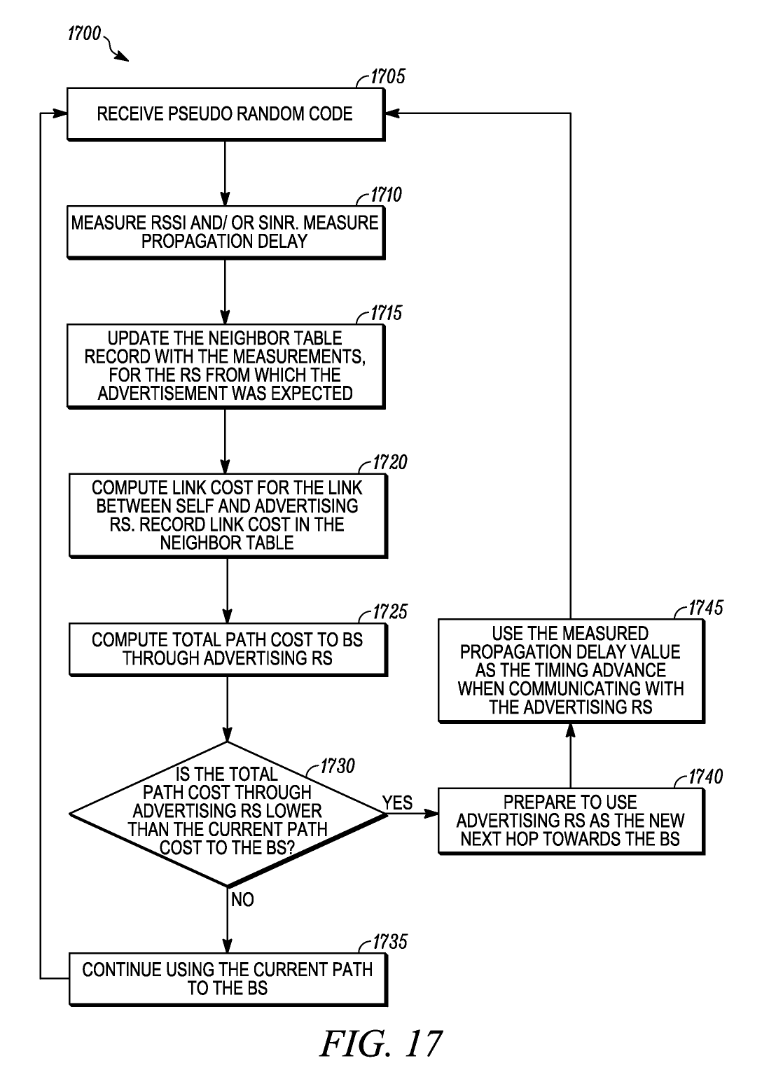

The process 1700 followed by a relay station 115-n upon receiving an RS Advertisement is shown in FIG. 17. As illustrated in FIG. 17, the relay station operation 1700 begins with Step 1705 when the relay station receives a pseudo random code. Next, in Step 1710, the relay station measures Received Signal Strength Indication (RSSI) and/or Signal to Interference plus Noise Ratio (SINR), and measures the propagation delay. Next, in Step 1715, the relay station updates its neighbor table record with the measurements for the relay station from which the RS advertisement was expected. Next, in Step 1720, the relay station computes link cost between itself and the advertising relay station. The relay station also records the computed link cost in its neighbor table. Next, in Step 1725, the relay station computes the total path cost to the base station through the advertising relay station. Next, in Step 1730, the relay station determines if the total path cost through the advertising relay station is lower than its current path cost to the base station. When the total path cost through the advertising relay station is not lower than the current path cost to the base station, the operation proceeds to Step 1735 and the relay station continues using the current path to the base station. The operation then cycles back to Step 1705 awaiting receipt of a pseudo random code. When, in Step 1730, the total path cost through the advertising relay station is lower than the current path cost to the base station, the operation proceeds to Step 1740 in which the relay station prepares to use the advertising relay station as the new next hop towards the base station. Next, in Step 1745, the relay station uses the measured propagation delay value as the timing advance when communicating with the advertising relay station. The operation then cycles back to Step 1705 awaiting receipt of a new pseudo random code.

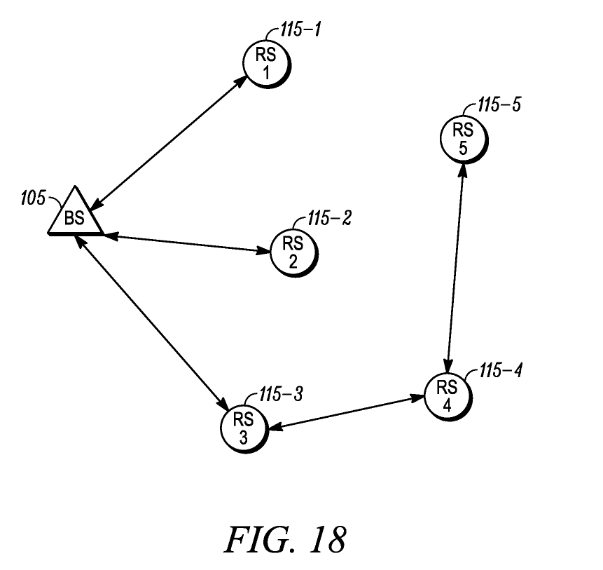

RS5 115-5, for example, can now compute the path metric to the base station 105 through RS4 115-4 and switch its next hop to RS4 115-4, as shown in FIG. 18.

The present invention provides a novel approach for path selection by a Relay Station (RS) in a wireless communication network such as an IEEE 802.16j network. This approach employs a mechanism such that each relay can measure the propagation delay to possible next-hop candidates. The delay is calculated using pseudorandom code transmission and is stored in the neighbor table at each RS. The RS also uses a path metric to the BS when selecting the next hop. This path metric is conveyed by the BS by reusing the bandwidth allocation mechanism.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method of operation of a relay station within a multihop network, the multihop network comprising at least one base station, the relay station, and a plurality of other relay stations, the method comprising:
maintaining a current base station path metric from the relay station to the base station;
maintaining a relay station link metric from the relay station to each of a plurality of other relay stations;
computing the base station path metric to the base station through each of the other relay stations;
comparing the current base station path metric and each of the computed base station path metrics through each of the other relay stations;
selecting a path for routing messages from the relay station to the base station using the comparing step; and
informing the base station of the path metric of the selected path to the base station.

2. A method of operation of a relay station within a multihop network as claimed in claim 1, wherein the step of computing the base station path metric to the base station through each of the other relay stations includes using one or more relay station path parameters associated with the other relay station, wherein the relay station path parameters are selected from a group comprising a path cost between the base station and the other relay station, a propagation delay, a physical layer signal quality, a load on the other relay station, a size of the other relay station's internal queues and a busyness of a neighborhood surrounding the other relay station.

3. A method of operation of a relay station within a multihop network as claimed in claim 1, wherein the path metric comprises a path cost.

4. A method of operation of a relay station within a multihop network as claimed in claim 1, further comprising:
broadcasting the base station path metric from the relay station to the base station to at least one of the plurality of other relay stations.

5. A method of operation of a relay station within a multihop network as claimed in claim 1, further comprising:
storing the relay station link metrics and the base station path metric through each of the plurality of other relay stations in a neighbor table in the relay station.

6. A method of operation of a relay station within a multihop network as claimed in claim 1, wherein the base station communicates with a backhaul having an associated cost, and wherein the base station path metric is determined using the associated cost of the backhaul.

7. A method of operation of a relay station within a multihop network as claimed in claim 1, further comprising:
receiving at least one other base station path metric from at least one other base station;
comparing the at least one other base station metric with the base station path metric; and
selecting an associating base station using the comparing step.

8. A method of operation of a relay station within a multihop network, the multihop network comprising at least one base station, the relay station, and a plurality of other relay stations, the method comprising:
receiving an advertising message from an advertising relay station and computing a path cost to the base station through the advertising relay station;
comparing the path cost through the advertising relay station to a current path cost for a current path;
using the advertising relay station as a next hop towards the base station when the path cost through the advertising relay station is lower than the current path cost to the base station; and
continuing to use the current path to the base station when the path cost through the advertising relay station is not lower than the current path cost to the base station.

9. A method of operation of a relay station within a multihop network as claimed in claim 8, further comprising:
measuring one or more parameters selected from a group comprising Received Signal Strength Indication (RSSI), Signal to Interference plus Noise Ratio (SINR), and a propagation delay; and
using the measured propagation delay value as a timing advance when communicating with the advertising relay station.

10. A method of operation of a relay station within a multihop network as claimed in claim 9, further comprising:
updating a neighbor table record within the relay station for the advertising relay station with the measurements for the one or more parameters.

11. A method of operation of a relay station within a multihop network comprising:
receiving an allocation message including a relay station advertisement opportunity, wherein the relay station advertisement opportunity includes a relay station identification (RSID), a pseudo random code identification (PSID), a cost, and a timing offset;
comparing the RSID with the identification of the relay station, and when the RSID is the identification of the relay station:
determining a pseudo random code to transmit using the PSID;
computing a relay station timing offset to use while transmitting the pseudo random code using a total timing offset equal to the timing offset in the received relay station advertisement opportunity plus the timing offset to a previous hop towards a base station; and
scheduling transmission of the determined pseudo random code sequence at a specified time with the computed timing offset.

12. A method of operation of a relay station within a multihop network as claimed in claim 11, further comprising:
transmitting the determined pseudo random code sequence at the specified time.

13. A method of operation of a relay station within a multihop network as claimed in claim 11, further comprising when the RSID is not the identification of the relay station:
compiling a new information element for transmission including:
the RSID received in the relay station advertisement opportunity,
the PSID received in the relay station advertisement opportunity,
the cost from the relay station to the base station received in the relay station advertisement opportunity, and
a total timing offset equal to the value in the received relay station advertisement opportunity plus the timing offset to the previous hop towards the base station;
scheduling an allocation message transmission with the prepared allocation message;
preparing for a PSID reception at the specified time by offsetting the local clock by an amount equal to the new computed timing offset.

14. A method of operation of a relay station within a multihop network as claimed in claim 13, further comprising:
transmitting the prepared allocation message.

15. A method of operation of a relay station within a multihop network as claimed in claim 11, further comprising when the RSID is not the identification of the relay station:
determining that there are no other relay stations downstream from the relay station; and
choosing not to forward the relay station advertisement opportunity.

16. A method of operation of a relay station within a multihop network as claimed in claim 11 herein the allocation message is an uplink-MAP.

17. A method of operation of a relay station within a multihop network as claimed in claim 14, wherein the uplink-MAP message includes an uplink MAP message (UL-MAP) extended information element.

18. A method of operation of a base station within a multihop network comprising:
determining a path cost from a relay station to the base station using an association table stored in the base station;
selecting a pseudo random sequence for the relay station to transmit;
compiling an allocation message including an identification of the relay station, the pseudo random sequence, a timing offset and the path cost; and
transmitting the allocation message for providing the relay station advertisement opportunity to the relay station.

19. A method of operation of a base station within a multihop network as claimed in claim 18, further comprising:
storing the selected pseudo random sequence in the association table.

20. A method of operation of a base station within a multihop network as claimed in claim 18 further comprising prior to the determining step:
receiving a local scheduler instruction to schedule a relay station advertisement opportunity for the relay station.

21. A method of operation of a base station within a multihop network as claimed in claim 18 wherein the allocation message comprises an uplink MAP information element including:
an identification of the relay station;
an identification of the pseudo random code;
a timing offset set to zero; and
a path cost.

22. A method of operation of a base station within a multihop network as claimed in claim 18, wherein the allocation message further comprises a start time of the allocation and a duration of the allocation.

23. A method of operation of a base station within a multihop network as claimed in claim 20 further comprising:
storing a relay station advertisement interval for the relay station prior to the determining step, and
determining the start time of the allocation and a periodicity of the allocation using the relay station advertisement interval.

24. A method of operation of a base station within a multihop network as claimed in claim 18, wherein the base station communicates with a backhaul having an associated cost, and wherein the step of determining the path cost from the relay station to the base station uses the associated cost of the backhaul.

25. A method of operation of a base station within a multihop network as claimed in claim 24, further comprising:
transmitting the path cost including the associated cost of the backhaul.

26. A method of operation of a network comprising a base station and a plurality of relay stations, the method comprising:
at the base station and at least one other relay station:
facilitating a transmission of a message by a first relay station, and
facilitating a reception of the message at one or more of the plurality of other relay stations,
wherein the facilitating steps provide for at one or more of the plurality of relay stations:
enabling a propagation delay measurement to a first relay station, and
enabling a link quality measurement to a first relay station.
